(19) United States
(12) Patent Application Publication
(10) Pub. No.: US 2013/0186696 A1
(43) Pub. Date: Jul. 25, 2013

(54) COMBINATION WEIGHER

(71) Applicants: Anne BROAGER, Egaa (DK); Torben MUELLER, Odder (DK); Gert HANSEN, Trige (DK)

(72) Inventors: Anne BROAGER, Egaa (DK); Torben MUELLER, Odder (DK); Gert HANSEN, Trige (DK)

(73) Assignee: MAREL A/S, Aarhus N (DK)

(21) Appl. No.: 13/358,068

(22) Filed: Jan. 25, 2012

(51) Int. Cl. G01G 13/00

(52) U.S. Cl. 177/52

(57) ABSTRACT

A combination weigher including a dispersion unit adapted to radially disperse product material dropped in from above onto the dispersion unit, plurality of weighing hoppers, plurality of conveyor units arranged around and below a periphery of the dispersion unit. The conveyor units include troughs having infeed ends positioned below the dispersion units and outfeed ends positioned above the weighing hoppers, and spiral shaped members extending from the infeed ends towards the outfeed ends. Spiral shaped members being operable connected to an operation unit for operating a rotational movement of the spiral shaped members conveying the product material from the infeed ends towards the outfeed ends into the weighing hoppers. Conical shaped members are arranged within the spiral shaped members.

### FIELD OF THE INVENTION

The present invention relates to a combination weigher.

### BACKGROUND OF THE INVENTION

U.S. 2009/277692 discloses a combination weighing apparatus including a dispersion unit, conveying units and weighing units. The dispersion unit is arranged to radially disperse product material. The conveying units are arranged around a periphery of the dispersion unit. The weighing units are arranged around a periphery of the conveying units. Each of the conveying units includes a trough. At least one of the troughs has a cross-sectional diameter that gradually increases generally from the infeed end to the outfeed end so that the one of the troughs and an adjacent one of the troughs are kept in contact with each other from the infeed ends to the outfeed ends. At least one of the conveying units has a spiral member disposed over a bottom surface of the trough. The spiral member is configured and arranged to convey the product material supplied from the dispersion unit toward the outfeed end of the trough. In one embodiment, a core element is arranged within the spiral shaped member so as to regulate the supply of product material into the conveying units, where the core element is either a cylinder having a diameter that is much less than the diameter of the spiral shaped member, or the core element is spiral member has a flared shape so that a spiral diameter of the spiral member gradually increases substantially from an infeed end toward an outfeed end.

The drawback of this reference is that due to the large difference between the inner diameter of the spiral shaped member and the core material many product material can be accumulated at the infeeding end so that piles of product material can easily be built up and be conveyed at a time, instead of a sequence of discrete product material, but this is typically an underiable scenario when batches of pre-fixed weight are being formed. Also, product material can easlily fall down at the bottom of the trough closed to the in-feed end and stay there, i.e. not be conveyed via the spiral shaped member. Further, the fact that the trough has a cross-sectional diameter that gradually increases from the infeed end to the outfeed end means that two or more items positioned side by side may be conveyed and fall simultaneously into the weighing units and thus go over the preferred weight in the storage/weighing hopper.

Also, the increasing diamater of the trough requires larger weighing units which results in that the overall size of the hopper may become to large. Finally, due to the geometry of the core element the product material can easility stick on the core material in the spiral shaped member.

The inventor of the present invention has appreciated that there is thus a need for an improved combination weigher and has in consequence devised the present invention.

### SUMMARY OF THE INVENTION

It would be advantageous to achieve an improved combination weigher that is capable of producing a discrete infeeding of product material into the weighing hoppers and is thus capable of effectively and accurately produce better target weight of batches. In general, the invention preferably seeks to mitigate, alleviate or eliminate one or more of the above mentioned disadvantages singly or in any combination. In particular, it may be seen as an object of the present invention to provide a combination weigher that solves the above mentioned problems, or other problems, of the prior art.

To better address one or more of these concerns, in a first aspect of the invention combination weigher is provided, comprising:

a dispersion unit adapted to radially disperse product material dropped in from above onto the dispersion unit,

plurality of weighing hoppers,

plurality of conveyor units arranged around and below a periphery of said dispersion unit, they conveyor units including:

troughs having infeed ends positioned below the dispersion units and outfeed ends positioned above said weighing hoppers, and

spiral shaped members extending from said infeed ends towards said outfeed ends, the spiral shaped members being operable connected to an operation unit for operating a rotational movement of the spiral shaped members and thus the conveying of the product material from said infeed ends towards said outfeed ends and into said weighing hoppers,

wherein the combination apparatus further comprises conical shaped members are arranged within said spiral shaped members with the wider ends positioned adjacent to said infeed ends of the troughs and the narrower end extending towards said outfeed ends of the troughs.

In one embodiment, the diameter of the spiral shaped member is constant along the longitudinal axis of the spiral shaped member.

In one embodiment, the diameter of the wider end of the conical shaped member is substantially the same as the inner diameter of the spiral shaped member.

Accordingly, by arranging such conical shaped members within the spiral shaped member the product material will no longer stick on the conical shaped member, firstly due to gravity (inclining surface) and less friction force since the surface area of the conical shaped member interacting with the product material becomes less with decreasing diameter.

Also, by implanting conical member with where the diameter at the larger size is substantially the same as the inner diameter of the spiral shaped member, it is thus ensured that one product material will enter the conveyor units at a time and that subsequent product materials will automatically be blocked and move to the next conveyor unit. Accordingly, it is prevented that a formation of pool of product material will be built up at the infeed ends of the conveyor units but instead a stream of single product material will enter the conveyor units at a time and therefore a sequence of product material is generated in the conveyor units which will enhance the accuracy in generating batches of pre-determined target weight.

In one embodiment, the length along the longitudinal axis of the conical shaped member is at least the same as the length between two adjacent windings of the spiral shaped member.

In one embodiment, the conical shaped member is exchangeable. Accordingly, in case implementing the combination weigher for different types of product material having different geometry it may be preferred to replace the conical shaped member with a new one having different length, or in case the target weight of the batch sizes are to become bigger/smaller or the time to generate these batches is to be different a different length of conical shaped member may be preferred.

In one embodiment, said conical shaped member has a smooth surface area. This is to minimize the interfacial area between the product material and the product material. Also, special coatings on the conical shaped member may be provided to reduce the friction between the product material and the conical shaped member even further

In one embodiment, said conical shaped member is stationary. In another embodiment, conical shaped member is rotating during use. The rotation may either be synchronized with the rotation of the spiral shaped member, or it may rotated faster or slower, or even rotate in the opposite direction to the spiral shaped member. In one embodiment, the spiral shaped member is an integral part of the spiral shaped member so that they rotate on a common rotation axis.

In one embodiment, said distribution unit is a rotating unit so as to allow the product material dropped in from above onto the dispersion unit to distribute in a substantial even way between the conveyor units. This distribution unit may be a center cone.

In another embodiment, the distribution unit is revolving chute. Such a chute may accordingly rotate with some frequency and/or speed between the different conveyor units and acts as an infeed unit. The chute may be provided with a detection mechanism for monitoring in which conveyor unit there is a shortage of product material and where there is no shortage, and based thereon control the infeed into the conveyor units.

In one embodiment, the inner diameter of the troughs is substantially the same as the outer diameter of the spiral shaped members. This is to prevent product material from sticking between the spiral shaped members and the troughs.

In one embodiment, the diameter of the spiral shaped members is substantially the same as the height between the bottom of the troughs and the distal end of the said center cone such that the spiral shaped member is adjacent to said distal end of the center cone. In that way, the troughs with the spiral shaped members act in a way as a direct extension of the distribution unit and provide an ease access of the single product material at a time through the infeed end.

In one embodiment the conveyor units further comprise upwardly extending walls at the opposite sides of the troughs extending upwardly from said distal end of the center cone, the upwardly extending walls of adjacent conveyor units being connected together via upwardly extending connection walls positioned adjacent to said distal end of the center cone so as to eliminate a space between said connection walls and the center cone and thus prevent product material position between adjacent conveyor units from falling through said space.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIGS. 1 and 2 show a perspective view and a top view of one embodiment of a combination weigher according to the present invention, and

FIG. 3 is an expanded view of a spiral shaped member with a conical shaped member.

### DESCRIPTION OF EMBODIMENTS

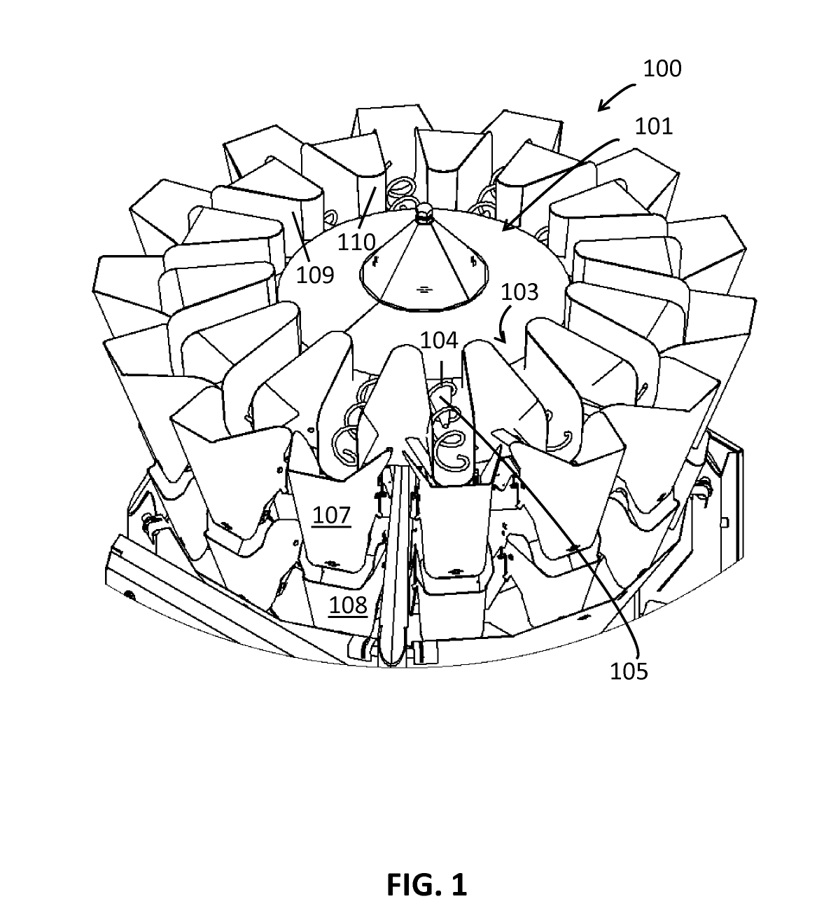

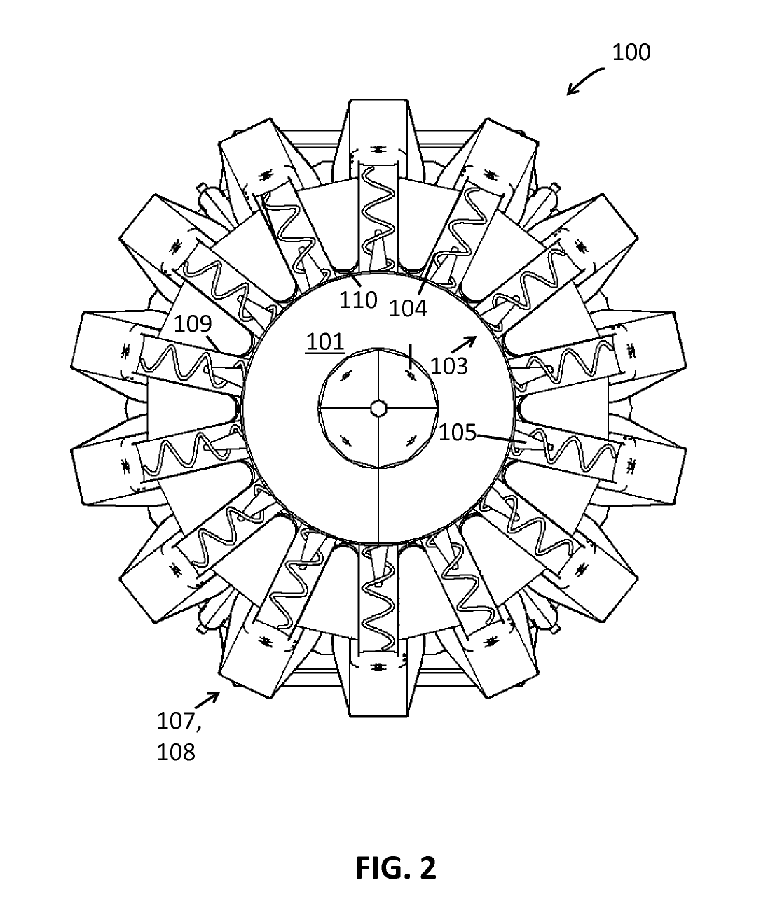

FIGS. 1 and 2 show a perspective view and a top view of one embodiment of a combination weigher 100 according to the present invention for producing batches of product material of pre-determined target weight. The product material may be, but is not limited to, any types of food items such as poultry breasts, liver etc. The combination weigher 100 comprises a dispersion unit 101, plurality of weighing hoppers 108, plurality of conveyor units 103 and spiral shaped members 104.

The dispersion 101 should not be construed as being limited to the center cone shown here that preferably is rotating to ensure that the product material (not shown) dropped from above onto the dispersion units becomes evenly distributed along the dispersion unit. It may just as well be a revolving chute that acts as an infeed station for the conveyor units 103, where the revolving chute may be provided with a detection mechanism such as an imaging mechanism to monitor in which conveyor units there is a shortage of product material. For simplicity, in the following, it will be assumed that the dispersions unit is the center cone 101 shown here.

In the embodiment depicted here, storage hoppers 107 are arranged above the weighing hoppers 108 for collecting portions of product material which is subsequently dropped down into the weighing hoppers. A typical operation cycles, which is well known to a skilled person in the art, is following: As soon as the sum of e.g. 3 weighing hoppers 108 gives a result that is closest to the target weight of e.g. 400 g (e.g. the summed up weight is 401 g), they are emptied simultaneously into a common compartment below the combination weigher and subsequently closed again. Upon closing the storage hoppers 107 are notified via e.g. automatically triggered signal to empty the product material that has during this been collected into these three weighing hoppers. During this, the procedure is continued for the remaining weighing hoppers, i.e. the most optimal weighing hoppers are selected where the total weight is closest to the target weight of the portion to be generated. An example of the functioning generating batches is given in U.S. 2009/0277692 hereby incorporated in it's entirety by reference.

The conveyor units 103 are arranged around and below a periphery of the dispersion unit 101 and include troughs having infeed ends positioned below and adjacent to the dispersion units 101 and outfeed ends positioned above said weighing hoppers 108, or as depicted in the scenario shown here above the storage hoppers 107. The conveyor units 103 further include spiral shaped members 104 extending from the infeed ends towards said outfeed ends of the troughs, but the spiral shaped members are operable connected to an operation unit (not shown) for operating a rotational movement of the spiral shaped members and thus the conveying of the product material from the infeed ends towards the outfeed ends and into said weighing hoppers 108, in this case via the storage hoppers 107.

Conical shaped members 105 are arranged within the spiral shaped members 104 such that their wider ends are positioned adjacent to the infeed ends of the troughs and the narrower ends extend towards the outfeed ends of the troughs. The diameter of the wider end of the conical shaped member is preferably substantially the same as the inner diameter of the spiral shaped member so as to prevent that too many product materials enter the conveyor units. The conical shaped member may be an integral part of the spiral shaped member or be exchangeable so that it may e.g. be replaced for another conical shaped member that is longer or shorter. Also, the conical shaped member may be stationary at all times, or be rotatable during operation, e.g. via a common rotation axis as the spiral shaped member, or it may be operable connected to another rotation axis that either rotates it at a different rotation velocity or in a opposite direction in relation to the spiral shaped member. The conical shaped member is preferably made of low friction material such as any types of plastic material, or aluminum or aluminum alloy, stainless steel and the like.

In one embodiment, the length of the length along the longitudinal axis of the conical shaped member is at least the same as the length between two adjacent windings of the spiral shaped member.

In the embodiment shown here, the diameter of the spiral shaped members 105 is constant along the longitudinal axis of the spiral shaped members. However, is should be noted that the diameter may just as well be continuously increasing from the infeed end towards the outfeed end.

The embodiment in FIGS. 1 and 2 show that the conveyor units 103 further comprise upwardly extending walls 109 at the opposite sides of the troughs extending upwardly and above said distal end of the center cone. The upwardly extending walls of adjacent conveyor units are connected together via upwardly extending connection walls 110 positioned adjacent to the distal end of the center cone so as to eliminate a space between the connection walls and the center cone and thus prevent product material position between adjacent conveyor units from falling through said space. As depicted here, these connection walls along with the side walls of adjacent conveyor units 103 are smoothly bended single piece of plate material made of e.g. stainless steel.

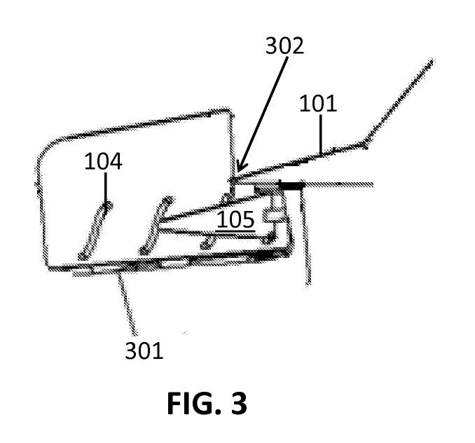

FIG. 3 shows an expanded view of the spiral shaped member/rod 104 and the conical shaped member 105 arranged within the spiral shaped rod 104. Accordingly, the diameter of the conical shaped member at the wider end is substantially the same as the inner diameter of the spiral shaped rod.

Also, preferable, the inner diameter of the troughs 301 is substantially the same as the outer diameter of the spiral shaped members so as to prevent product material from being clamped between the spiral shaped rod and said walls 109.

As depicted here, the diameter of the spiral shaped members 104 (spiral shaped rod) is substantially the same as the height between the bottom of the troughs 301 and the distal end 302 of the said center cone 101 such that the spiral shaped member is adjacent to said distal end of the center cone.

It should be noted that the troughs are typically close to being horizontal, or have non limiting angle between 1-5° declining angle from the dispersion unit towards the hoppers so as to enhance the cleaning therein.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. A combination weigher, comprising:
a dispersion unit adapted to radially disperse product material dropped in from above onto the dispersion unit,
plurality of weighing hoppers,
plurality of conveyor units arranged around and below a periphery of said dispersion unit, they conveyor units including:
troughs having infeed ends positioned below the dispersion units and outfeed ends positioned above said weighing hoppers, and
spiral shaped members extending from said infeed ends towards said outfeed ends, the spiral shaped members being operable connected to an operation unit for operating a rotational movement of the spiral shaped members and thus the conveying of the product material from said infeed ends towards said outfeed ends and into said weighing hoppers,
wherein the combination apparatus further comprises conical shaped members are arranged within said spiral shaped members with the wider ends positioned adjacent to said infeed ends of the troughs and the narrower end extending towards said outfeed ends of the troughs.

2. A combination weigher according to claim 1, wherein the diameter of the spiral shaped member is constant along the longitudinal axis of the spiral shaped member.

3. A combination weigher according to claim 1, wherein the diameter of the wider end of the conical shaped member is substantially the same as the inner diameter of the spiral shaped member.

4. A combination weigher according to claim 1, wherein the length along the longitudinal axis of the conical shaped member is at least the same as the length between two adjacent windings of the spiral shaped member.

5. A combination weigher according to claim 1, wherein the conical shaped member is exchangeable.

6. A combination weigher according to claim 1, wherein said conical shaped member has a smooth surface area.

7. A combination weigher according to claim 1, wherein said conical shaped member is stationary.

8. A combination weigher according to claim 1, wherein said conical shaped member is rotating during use.

9. A combination weigher according to claim 1, wherein said distribution unit is a rotating unit so as to allow the product material dropped in from above onto the dispersion unit to distribute in a substantial even way between the conveyor units.

10. A combination weigher according to claim 1, wherein said distribution unit is a center cone.

11. A combination weigher according to claim 1, where said distribution unit is revolving chute.

12. A combination weigher according to claim 1, wherein the inner diameter of the troughs is substantially the same as the outer diameter of the spiral shaped members.

13. A combination weigher according to claim 10, wherein the diameter of the spiral shaped members is substantially the same as the height between the bottom of the troughs and the distal end of the said center cone such that the spiral shaped member is adjacent to said distal end of the center cone.

14. A combination weigher according to claim 13, wherein the conveyor units further comprise upwardly extending walls at the opposite sides of the troughs extending upwardly and above said distal end of the center cone, the upwardly extending walls of adjacent conveyor units being connected together via upwardly extending connection walls positioned adjacent to said distal end of the center cone so as to eliminate a space between said connection walls and the center cone and thus prevent product material position between adjacent conveyor units from falling through said space.
